(19) United States
(12) Patent Application Publication
(10) Pub. No.: US 2009/0165011 A1
(43) Pub. Date: Jun. 25, 2009

(54) RESOURCE MANAGEMENT METHOD, INFORMATION PROCESSING SYSTEM, INFORMATION PROCESSING APPARATUS, AND PROGRAM

(76) Inventors: Hideharu Kato, Yokohama (JP); Yoshimasa Masuoka, Kunitachi (JP)

Correspondence Address: MATTINGLY & MALUR, P.C., 1800 DIAGONAL ROAD, SUITE 370, ALEXANDRIA, VA, 22314, US

(21) Appl. No.: 12/039,356

(22) Filed: Feb. 28, 2008

(30) Foreign Application Priority Data
Dec. 20, 2007 (JP) 2007-329043

(51) Int. Cl. G06F 9/46

(52) U.S. Cl. 718/104

(57) ABSTRACT

In an information processing system, a configuration information management apparatus stores an identifier of a resource of a management target apparatus and a resource address of the management target resource, in association with each other. The management target apparatus stores destination information and the identifier of the management target resource, in association with each other, the destination information used when the configuration information management apparatus receives event notification from the management target resource. The management target apparatus transmits the identifier of the resource and a current (the latest) resource address when transmitting the event notification of the management target resource to the configuration information managing apparatus. The configuration information managing apparatus receives the event notification, the identifier of the resource, and the current resource address and changes the stored resource address which is associated with the acquired identifier of the resource into the acquired current resource address.

### CROSS-REFERENCE TO RELATED APPLICATIONS

The present application claims a priority from Japanese Patent Application No. 2007-329043 filed on Dec. 20, 2007, the content of which herein incorporated by reference.

### BACKGROUND OF THE INVENTION

1. Field of the Invention

This invention relates to a resource management method for an information processing apparatus in an information processing system, or more particularly to a technique for enabling efficient and appropriate management of resources even when information for identifying or specifying a resource being a management target is changed.

2. Related Art

Information processing systems in business organizations and the like are becoming larger in scale and more complicated in recent years. Hence, it is required that resources held in such information processing systems be efficiently and easily operated and managed. Moreover, with the progress in diversification and multi-vendor application of information processing apparatuses being management targets, even when the configuration of an information processing system is changed, such resources should be efficiently and promptly adjusted to the change.

Incidentally, when managing resources including an information processing apparatus, an operating system, application software, and the like in an information processing system, it is necessary to identify and specify the resources being management targets reliably. Accordingly, information for specifying the resources (hereinafter referred to as “resource addresses”) needs to be managed appropriately (see U.S. Patent Application Publication No. US 2006/0136585, for example). For reference for information management techniques, also see: CMDBf (CMDB Federation), [online], [searched on Nov. 22, 2007], the Internet <URL: http://cmdbf.org/>; and Distributed Management Task Force, Inc., “Common Information Model (CIM) Standards”, [online], [searched on Nov. 22, 2007], the Internet <URL: http://www.dmtf.org/standards/CIM/>.

However, it is not always easy to manage resource addresses appropriately in a large-scaled and complicated information processing system. For example, an IP (Internet protocol) address or a host name may be changed if a management target apparatus is relocated. Meanwhile, a media access control (MAC) address is changed if a network interface card (NIC) is replaced. Moreover, if the management target apparatus is a virtual machine, a MAC address (a virtual MAC address) and an IP address of the management target apparatus are changed when so-called cold migration takes place.

Conventionally, an operator manually updates resource addresses when the resource addresses are changed as described above. Therefore, in a large-scaled and complicated information processing system, such updating operations may cause enormous operational burdens.

### SUMMARY OF THE INVENTION

The present invention has been made in view of the above-described circumstances. An object of the present invention is to provide a resource management method, an information processing system, an information processing apparatus, and a program which are capable of managing resources efficiently and appropriately even when information for identifying or specifying a resource being a management target is changed.

One aspect of the present invention for solving the problem provides a resource management method which is configured to cause a first information processing apparatus that is communicably connected to a second information processing apparatus to execute the steps of storing an identifier of a resource, which is a management target, of the second information processing apparatus, and a resource address being information for specifying the resource, in association with each other, causing the second information processing apparatus to store destination information and the identifier of the resource, in association with each other, the destination information used for the first information processing apparatus to receive an event notification from the resource, acquiring the identifier of the resource and a resource address currently given to the resource upon reception of the event notification from the resource, and changing the stored resource address which is associated with the acquired identifier of the resource into the acquired current resource address.

According to the present invention, it is possible to manage resources efficiently and appropriately even when information for identifying or specifying a resource being a management target is changed.

### BRIEF DESCRIPTION OF THE DRAWINGS

FIG. 1 is a view showing a configuration of an information processing system 1 explained as an embodiment of the present invention;

FIG. 2 is a view showing an example of a hardware configuration of an information processing apparatus (a computer) used as a configuration information managing apparatus 100, a management target apparatus 101, and an information-use apparatus 102 explained as the embodiment of the present invention;

FIG. 3 shows functions to be performed by the configuration information managing apparatus 100, explained as the embodiment of the present invention, and data stored in the configuration information managing apparatus 100;

FIG. 4 shows functions to be performed by the management target apparatus 101 explained as the embodiment of the present invention, and data stored in the management target apparatus 101;

FIG. 5 shows functions to be performed by the management target apparatus 101 explained as the embodiment of the present invention, and data stored in the management target apparatus 101;

FIG. 6 shows functions to be performed by the management target apparatus 101 explained as the embodiment of the present invention, and data stored in the management target apparatus 101;

FIG. 7 is a view showing a configuration of the management target apparatus 101 when the management target apparatus 101 explained as the first embodiment of the present invention is a virtual machine;

FIG. 8 is a view showing migration of the management target apparatus 101 (the virtual machine) explained as the embodiment of the present invention;

FIG. 9 is a flowchart showing a process executed by a resource address finding unit 301 explained as the embodiment of the present invention;

FIG. 10 is a flowchart showing a process executed by a resource address registering unit 302 explained as the embodiment of the present invention;

FIG. 11 is a flowchart showing a process to be executed by a resource address notification event registering unit 304 explained as the embodiment of the present invention;

FIG. 12 is a flowchart showing a process (of a pull type) to be executed by a resource information collecting and updating unit 303 explained as the embodiment of the present invention;

FIG. 13 is a flowchart showing a process to be executed by an event message analyzing unit 305 explained as the embodiment of the present invention;

FIG. 14 is a flowchart showing a process to be executed by a resource address updating unit 307 explained as the embodiment of the present invention;

FIG. 15 shows an example of a management endpoint table 310 explained as the embodiment of the present invention;

FIG. 16 shows an example of a resource address based on WS-Addressing explained as the embodiment of the present invention;

FIG. 17 shows an example of a resource list table 311 explained as the embodiment of the present invention;

FIG. 18 shows an example of a resource address notification event condition table 312 explained as the embodiment of the present invention;

FIG. 19 shows an example of an event notification destination address in the case of using WS-Management, which is explained as the embodiment of the present invention;

FIG. 20 shows an example of a resource information table 313 explained as the embodiment of the present invention;

FIG. 21 shows an example of an inter-resource correlation table 314 explained as the embodiment of the present invention;

FIG. 22 shows an example of a resource address notification event message explained as the embodiment of the present invention;

FIG. 23 is a flowchart showing an example of a resource address finding process (of a push type) explained as another embodiment of the present invention;

FIG. 24 is a flowchart showing an example of an event image analyzing process explained as the embodiment of the present invention;

FIG. 25 is a flowchart showing an example of a resource address finding process (of a push type) explained as the embodiment of the present invention;

FIG. 26 is a flowchart showing a process (of a push type) to be executed by a resource information collecting and updating unit explained as still another embodiment of the present invention;

FIG. 27 is a flowchart showing a process to be executed by an event message analyzing unit explained as the embodiment of the present invention;

FIG. 28 is a flowchart showing a process (of a push type) to be executed by a resource information collecting and updating unit explained as the embodiment of the present invention;

FIG. 29 is a view showing an example of an event notification registration (subscribe) request message explained as the embodiment of the present invention;

FIG. 30 is a view showing an example of an event notification registration request message explained as the embodiment of the present invention;

FIG. 31 is a view showing an example of a resource address notification event message explained as the embodiment of the present invention; and

FIG. 32 is a view showing an example of the event notification registration request message explained as the embodiment of the present invention.

### DETAILED DESCRIPTION OF THE INVENTION

Now, embodiments of the present invention will be described below in detail with reference to the accompanying drawings.

### First Embodiment

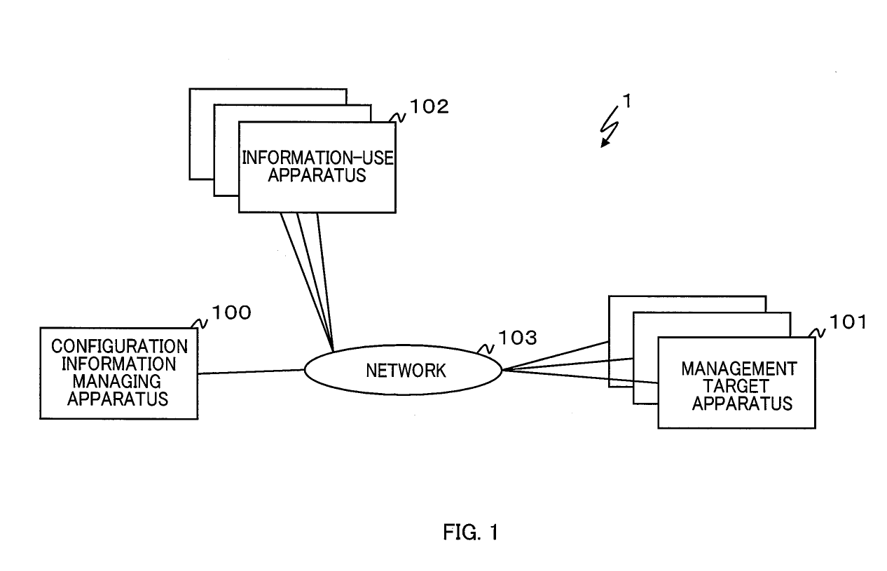

FIG. 1 shows a configuration of an information processing system 1 explained as an embodiment of the present invention. As shown in the drawing, this information processing system 1 includes a configuration information managing apparatus 100 (a first information processing apparatus), one or more management target apparatuses 101 (second information processing apparatuses), and one or more information-use apparatuses 102, these of which are communicably connected to one another through a communication network 103. The management target apparatus 101 is an information processing apparatus constituting management targets for the configuration information managing apparatus 100, and the information-use apparatus 102 is an information processing apparatus utilizing information offered by the configuration information managing apparatus 100.

The configuration information managing apparatus 100 collects information, which is used for configuration management of the management target apparatuses 101, from the management target apparatuses 101. The configuration information managing apparatus 100 offers information (hereinafter referred to as configuration information) created by use of the collected information to the information-use apparatuses 102. In addition to the information collected from the management target apparatuses 101, the configuration information managing apparatus 100 stores a variety of information on management of the management target apparatus 101 and offers that information to the information-use apparatuses 102.

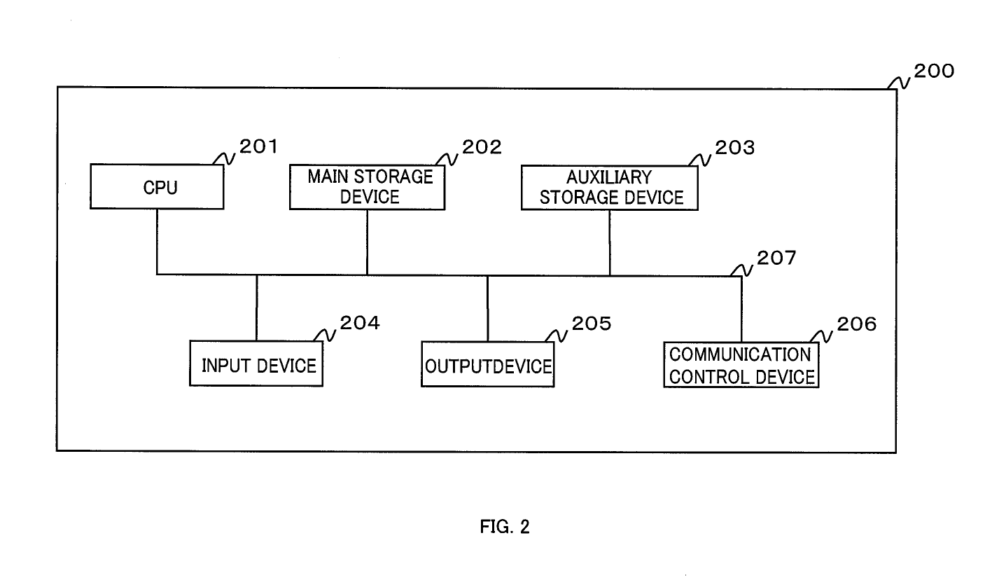

FIG. 2 shows an example of a hardware configuration of an information processing apparatus (a computer) which is used as the configuration information managing apparatus 100, the management target apparatus 101, and the information-use apparatus 102. An information processing apparatus 200 shown in the drawing includes: a CPU (central processing unit) 201, a main storage device 202 (a memory), an auxiliary storage device 203 such as a hard disk, an input device 204 such as a keyboard or a mouse, an output device 205 such as a display or a printer, a communication control device 206 which is a communication interface for establishing connection to the network 103, and a bus 207 for communicably connecting these devices to one another.

Here, each of the configuration information managing apparatus 100, the management target apparatus 101, and the information-use apparatus 102 may also be formed by use of multiple information processing apparatuses 200 having the configuration as shown in FIG. 2.

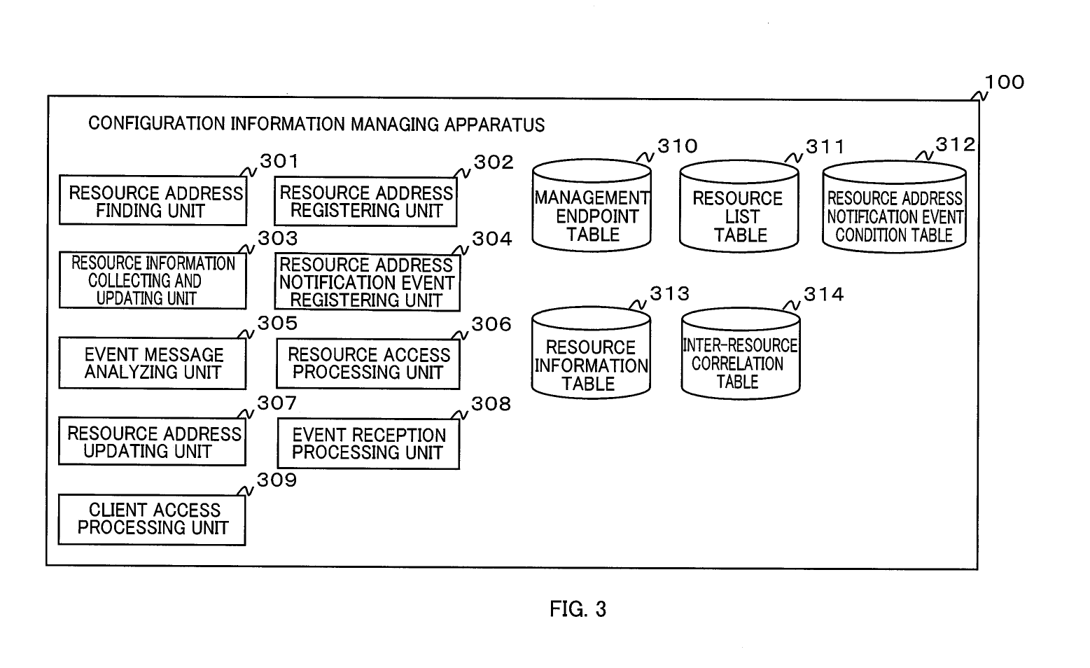

FIG. 3 shows functions to be performed by the configuration information managing apparatus 100 and data stored in the configuration information managing apparatus 100. Each function shown in the drawing is performed by the hardware of the configuration information managing apparatus 100 or by causing the CPU 201 to execute programs stored in the main storage device 202 or the auxiliary storage device 203.

As shown in FIG. 3, the configuration information managing apparatus 100 has functions such as a resource address finding unit 301, a resource address registering unit 302, a resource information collecting and updating unit 303, a resource address notification event registering unit 304, an event message analyzing unit 305, a resource access processing unit 306, a resource address updating unit 307, an event reception processing unit 308, and a client access processing unit 309. Moreover, the configuration information managing apparatus 100 stores a management endpoint table 310, a resource list table 311, a resource address notification event condition table 312, a resource information table 313, and an inter-resource correlation table 314.

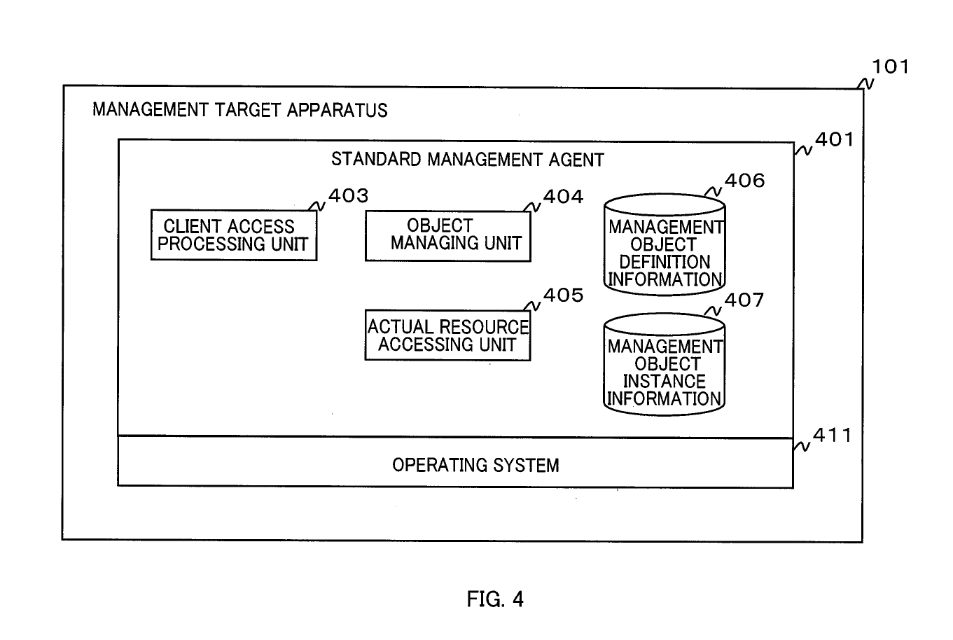

FIG. 4 shows functions to be performed by the management target apparatus 101, which is the management target of the configuration information managing apparatus 100, and data stored in the management target apparatus 101. Each function shown in the drawing is performed by the hardware of the configuration information managing apparatus 100 or by causing the CPU 201 to execute programs stored in the main storage device 202 or the auxiliary storage device 203.

As shown in the drawing, a standard management agent 401 is in operation in the management target apparatus 101. The standard management agent 401 offers functions such as to provide, to update, and to operate information concerning a resource being a management target (such a resource will be hereinafter referred to as a management target resource) through an interface in accordance with a standard operation management technique. As will be described later, the configuration information managing apparatus 100 collects the information on the management target resource by using the standard management interface of the standard management agent 401 which is in operation on each of the management target apparatuses 101. Concrete examples of the operation management technique include WS-Management standardized by the Distributed management Task Force (DMTF), the Common Information Model (CIM), and the like.

In the management target apparatus 101, the standard management agent 401 acquires a variety of information concerning the management target resource by using functions of an operating system 411 operating on the management target apparatus 101. For example, when the management target apparatus 101 has the hardware configuration shown in FIG. 2, the standard management agent 401 acquires, from the operating system 411, information concerning the hardware (the CPU 201, the main storage device 202, the auxiliary storage device 203, the input device 204, the output device 205, the communication control device 206, and the bus 207), information concerning processes to be executed under control of the operating system 411, information on the operating system 411, and so forth.

As shown in FIG. 4, the standard management agent 401 has functions of a client access processing unit 403, an object managing unit 404, and an actual resource accessing unit 405. Moreover, the standard management agent 401 has management object definition information 406 and management object instance information 407. Each function shown in the drawing is performed by the hardware of the management target apparatus 101 or by causing the CPU 201 to execute programs stored in the main storage device 202 or the auxiliary storage device 203.

Among the functions of the standard management agent 401, the client access processing unit 403 transmits and receives messages to and from a system such as the configuration information managing apparatus 100 which utilizes the functions of the standard management agent 401. Transmission and reception of the messages are executed in accordance with a standard protocol.

Among the functions of the standard management agent 401, the object managing unit 404 interprets a request such as for referring to, updating, and operating information concerning a management object representing the management target resource, as requests for the actual management target resource, and calls the actual resource accessing unit 405. The actual resource accessing unit 405 has a function of connecting to the actual management target resource, and information collected from the actual management target resource is responded with a management object instance.

Among the data managed by the standard management agent 401, the management object definition information 406 is definition information concerning a model for expressing the management target resource. The management target resource is expressed as the management object in accordance with the definition of a standard management model. Meanwhile, the management object instance is retained in the management object instance information 407.

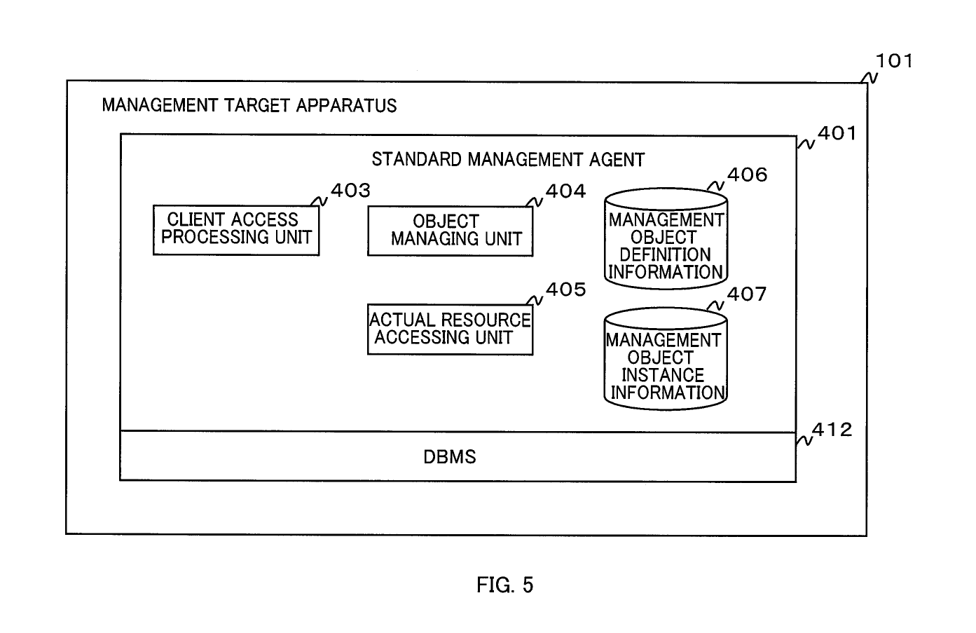

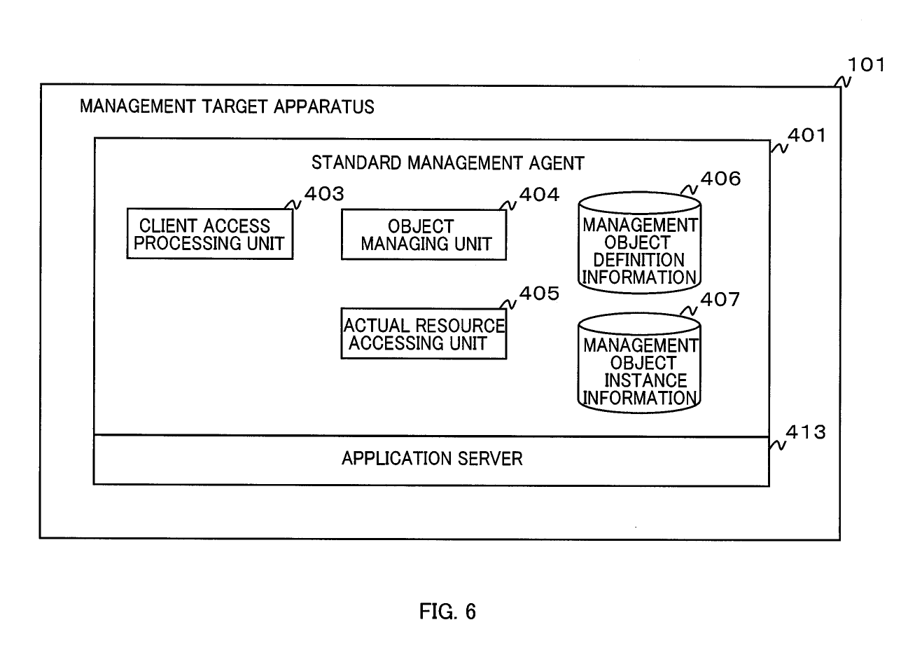

Incidentally, instead of the above-described configuration to work with the operating system 411, the standard management agent 401 may also be configured to work with a database management system (DBMS) 412 as shown in FIG. 5 and to acquire and manage information concerning the resource managed by the DBMS 412. Alternatively, as shown in FIG. 6, the standard management agent 401 may also be configured to work with an application server 413 and to acquire and manage information concerning a resource managed by the application server 413.

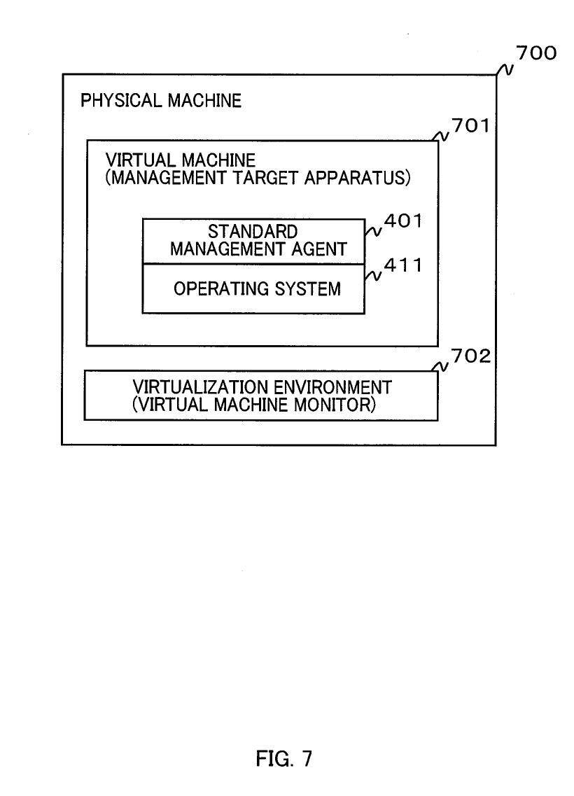

The management target apparatus 101 is not necessarily limited to a physical information processing apparatus. For example, the management target apparatus 101 may be a virtual information processing apparatus (a virtual machine) which is realized by a virtualization environment (a virtual machine monitor) that is operated by a physical information processing apparatus (a physical machine) (see FIG. 7). In this case, the virtualization environment offers, to the virtual machine, the physical hardware such as the CPU, the main storage device, the auxiliary storage device, the input device, the output device, and the communication control device collectively as a virtual apparatus.

Next, operations of each function of the configuration information managing apparatus 100 will be concretely described. First of all, a process to allow the configuration information managing apparatus 100 to find a resource address of the management target resource will be described.

Here, the resource address is the information used for identifying or specifying the resource of the management target apparatus 101. For example, when the management target resource is the information processing apparatus (the computer), the resource address is formed by use of a host name, an IP address, a MAC address, a manufacturer's name, a model name, a serial number, a system UUID (universally unique identifier), and the like. Meanwhile, when the management target resource is an operating system, the resource address is formed by use of a name and version information of the operating system, an identifier of the information processing apparatus, and the like. Moreover, when the management target resource is application software, the resource address is formed by use of a name and version information of the application software, an identifier either of the information processing apparatus installed with the software or of the operating system, and the like.

Conceivable methods of finding by the configuration information managing apparatus the resource address of the management target resource include a pull type and a push type. In the case of the pull type, the configuration information managing apparatus 100 issues, to the management target resource, a request for acquiring the resource address. On the other hand, in the case of the push type, the management target resource transmits the source address to the configuration information managing apparatus 100. As for the timing for collecting the resource address in the case of the pull type, the resource address may be collected periodically or collected upon a request from a user, for example. Meanwhile, as for the timing for collecting the resource address in the case of the push type, the resource address may be collected (transmitted) periodically or collected (transmitted) at the time of creating the resource, for example.

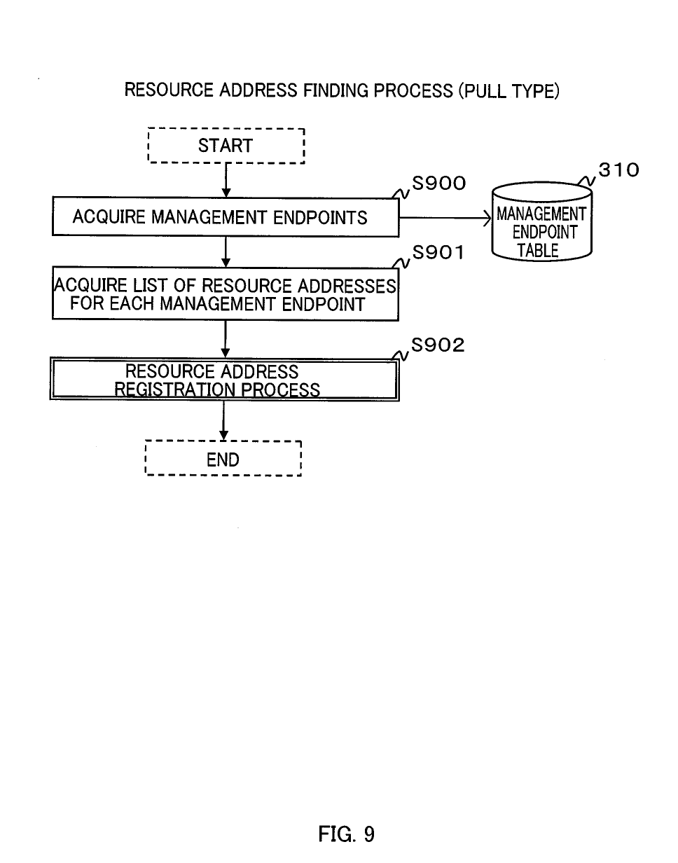

FIG. 9 is a flowchart for explaining a process for allowing the resource address finding unit 301 of the configuration information managing apparatus 100 to find the resource address of the management target resource, by using the pull type method. Note that letters “S” prefixed to reference numerals in the following explanation represent steps.

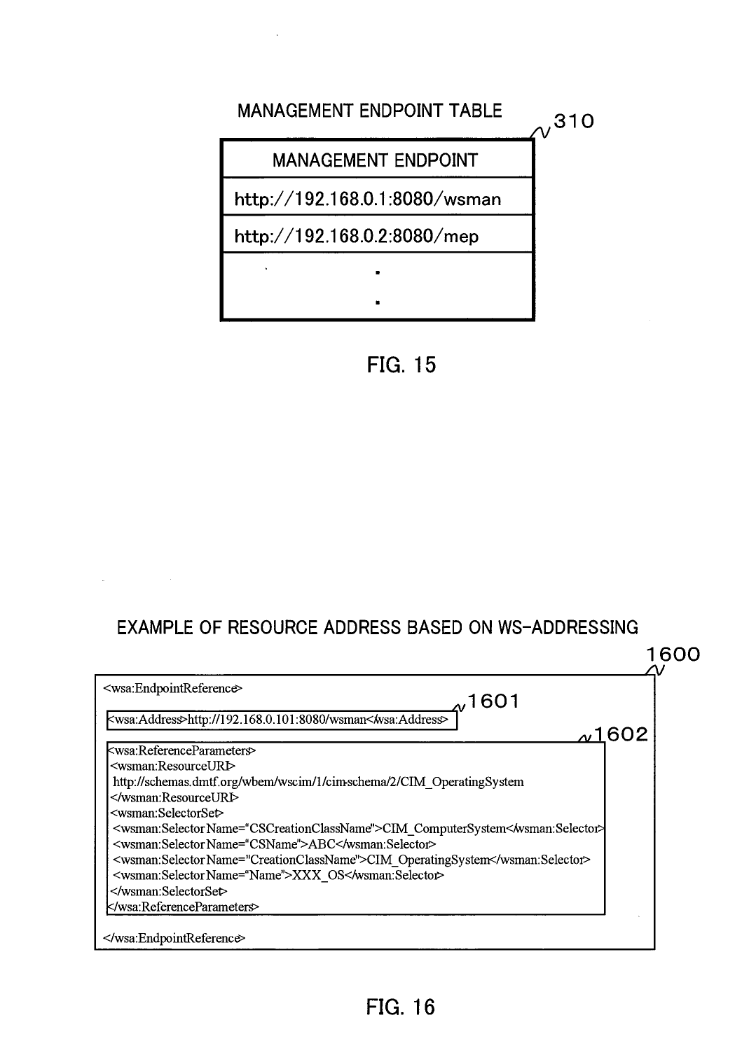

As shown in the drawing, the resource address finding unit 301 firstly acquires a management endpoint from the management endpoint table 310. The management endpoint is information that indicates an address for transmitting a request from the configuration information managing apparatus 100 to the standard management agent 401 on the management target apparatus 101. FIG. 15 shows an example of the management endpoint table 310. The standard management agent 401 provides a management function concerning multiple resources through the management end point.

The management endpoint may be manually registered in the management endpoint table 310 by an operator and the like. Alternatively, the configuration information managing apparatus 100 may find the management endpoint programmatically by means of communication with the standard management agent 401 using a protocol such as the Service Location Protocol (SLP) and register the management endpoint automatically.

Next, the resource address finding unit 301 communicates with the standard management agent 401 through the resource access processing unit 306 and acquires a resource address list of the resources managed by the standard management agent 401, each of which is linked with the corresponding management endpoint acquired from the management endpoint table 310 (S901).

The WS-Addressing is a typical technique for achieving such a scheme. The resource address based on the WS-Addressing is expressed as a combination of a Uniform Resource Locator (URL) representing the management endpoint and information for uniquely identifying the resource within the management endpoint. It is to be noted that the resource addresses are assumed to be based on the WS-Addressing in the following description.

FIG. 16 shows an example of a resource address based on the WS-Addressing. As shown in the drawing, a resource address 1600 includes a URL 1601 for indicating a management endpoint and information 1602 for specifying the resource within the management endpoint. When the standard management agent 401 complies with the WS-Addressing, the resource address list can be acquired by use of, for example, an Enumerate operation which is defined by the WS-Management.

Next, the resource address finding unit 301 calls the resource address registering unit 302 and registers the resource address acquired in S901 in the resource list table 311 (S902).

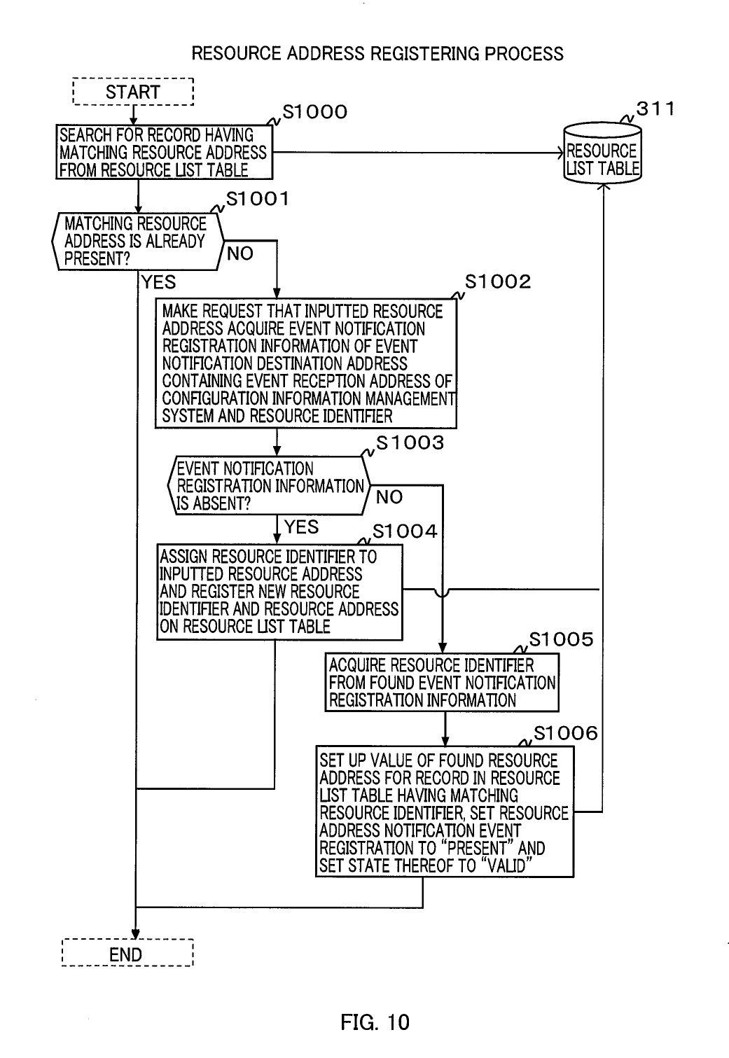

FIG. 10 is a flowchart for explaining a process to be executed by the resource address registering unit 302 in S902 in FIG. 9.

First, the resource address registering unit 302 searches for a resource address which matches with the acquired resource address, in the resource list table 311 (S1000).

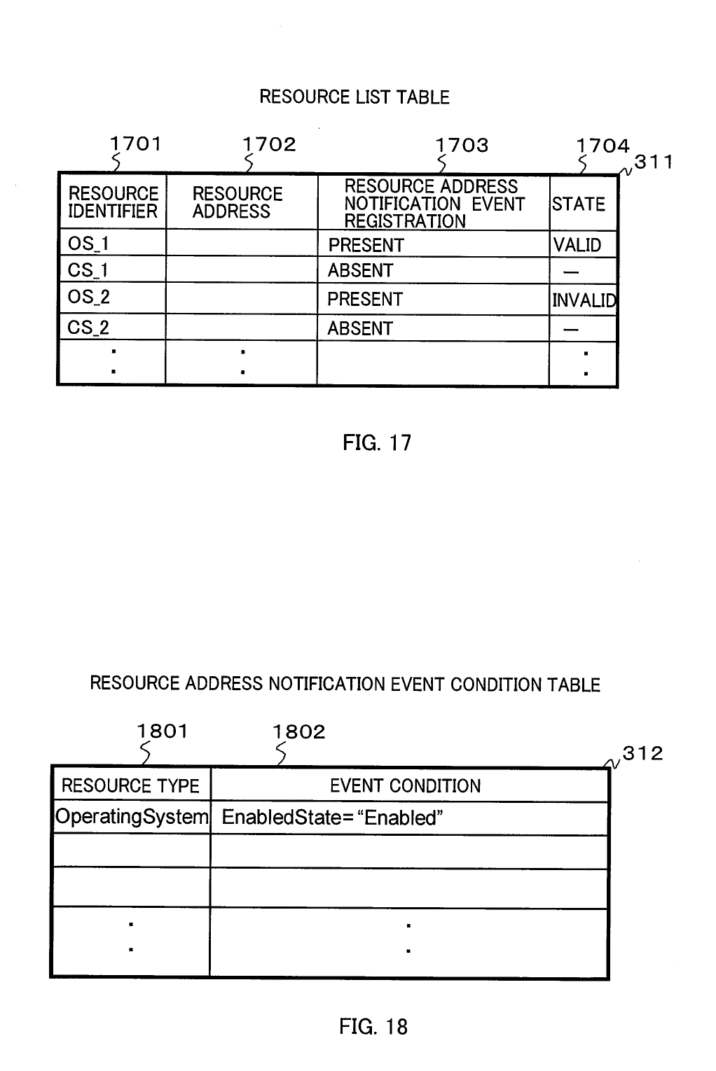

FIG. 17 shows an example of the resource list table 311. In the drawing, a resource identifier 1701 is identification information uniquely allocated to each management target resource by the configuration information managing apparatus 100. Reference numeral 1702 denotes the resource address. Meanwhile, reference numeral 1703 denotes information indicating presence or absence of resource address notification information event registration to be described later. Reference numeral 1704 denotes information indicating a state of the resource address. A word “valid” is registered in this reference numeral 1704 when the management target resource is accessible by using the resource address whereas a word “invalid” is registered when the management target resource is not accessible.

A state is registered in this reference numeral 1704 only when the resource address notification event registration is “present”. A corresponding record is usually deleted when the resource address is not usable. Here, however, the record is not deleted when the resource address notification event registration is “present,” and is retained while registering a word “invalid” in the reference numeral 1704.

Next, the resource address registering unit 302 checks whether or not the matching resource address exists in the resource list table 311 as a result of the process in S1000 (S1001). The process is terminated when the matching resource address exists (S1001: YES).

On the other hand, when no matching resource address exists (S1001: NO), a request for acquiring event notification registration information matching with the following conditions is sent to the inputted resource address (S1002).

Condition 1: An event notification destination address contains an event message reception endpoint of the configuration information managing apparatus 100.

Condition 2: The event notification destination address contains a resource identifier.

Now, the event notification registration information will be described. When a certain specific condition is satisfied, a request for transmission of a notification message to a certain specific address is sent to the standard management agent 401. This is called event notification registration (subscribe). For example, a conceivable event notification registration is “to cause the configuration information management apparatus 100 to transmit a notification message in the case where the management target resource is the operating system 411 and when an operating state of the operating system 411 is ‘stopped’ ”.

The standard management agent 401 monitors the management target resource while retaining the event notification registration received from the configuration information managing apparatus 100 as event notification registration information (subscription). Typical event notification registration information includes the event notification destination address, an event notification registration target resource (subscribe target resource) address, and an event firing condition.

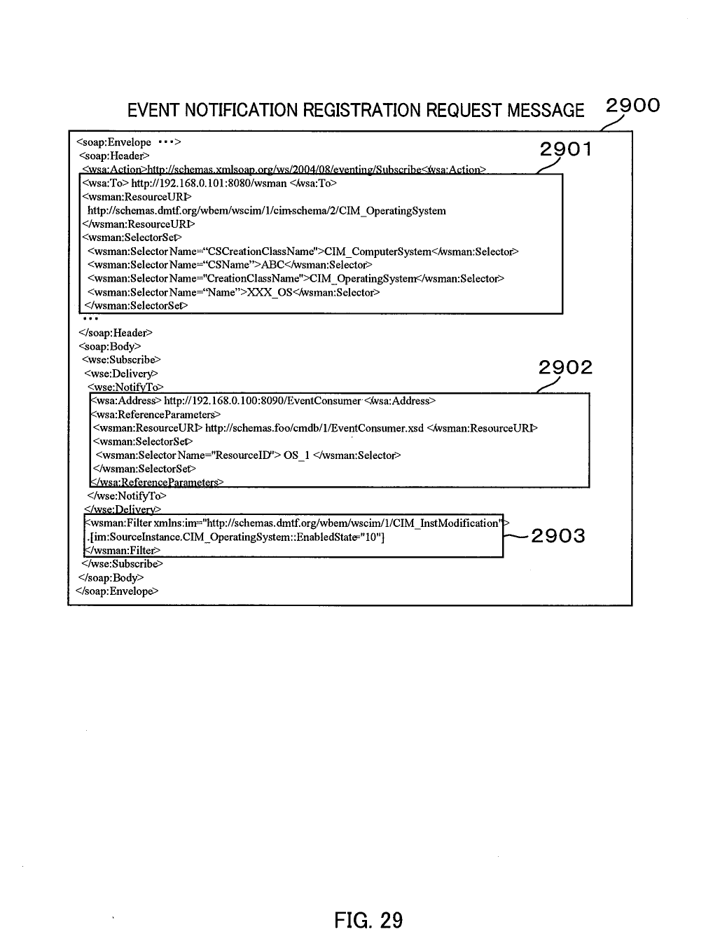

FIG. 29 shows an example of an event notification registration (subscribing) request message. In the drawing, reference numeral 2900 denotes an event notification registration request message. Reference numeral 2901 denotes information indicating the event notification registration target resource (subscribe target resource) address. Reference numeral 2902 denotes information indicating the event notification destination address. Reference numeral 2903 denotes information indicating the event firing condition.

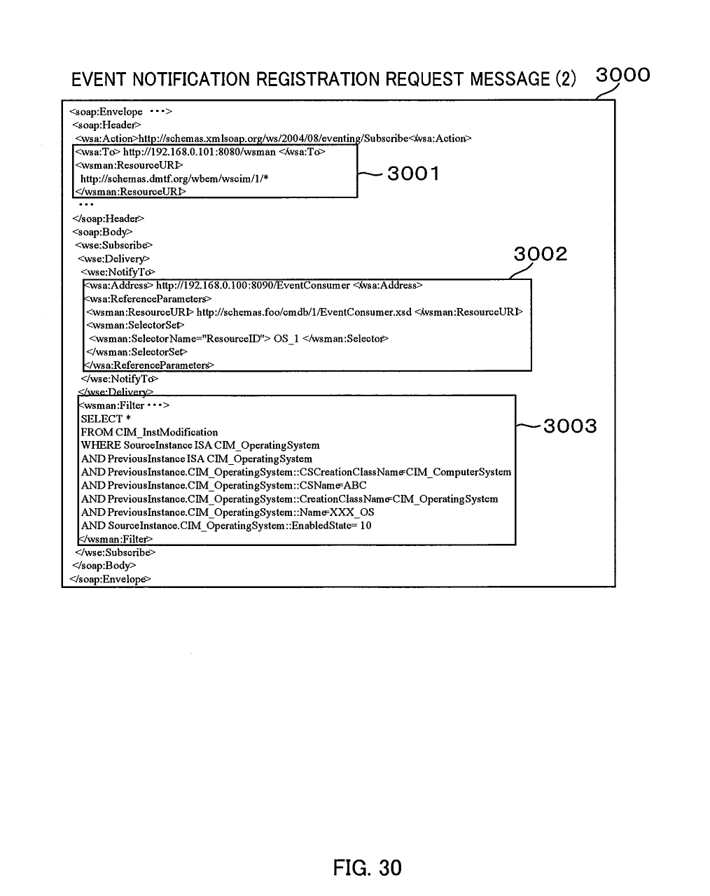

Although in the example shown in FIG. 29, the event notification registration target resource (subscribe target resource) address exists in a header section of a SOAP (Simple Object Access Protocol) message, it may exist in a body section of the SOAP message. FIG. 30 is a view showing an example of the event notification registration request message in the case where the information for specifying the event notification registration target resource exists in the body section of the SOAP message. In the drawing, reference numeral 3002 denotes the information for specifying the event notification registration target resource.

The standard management agent 401 has a function to offer the event notification registration information to outside.

When the standard management agent 401 complies with the WS-Management and the CIM, the event notification registration information is expressed by a CIM_IndicationFilter instance, a CIM_IndicationHandler instance, and a CIM_IndicationSubscription instance. These instances can be obtained by use of a Get operation defined by the WS-Management.

In S1003 in FIG. 10, the resource address registering unit 302 checks whether or not the event notification registration information matching with the aforementioned conditions is absent. When the event notification registration information is absent (S1003: YES), the resource identifier is assigned to the inputted resource address and then the resource identifier as well as the inputted resource address are newly registered in the resource list table 311 (S1004). In this new registration, the value of the resource address notification event registration 1703 is set to “absent,” and the value of the state 1704 is set to “valid”.

On the other hand, when the event notification registration information is not absent as a result of S1003 (S1003: NO), the resource identifier is acquired from the found event notification registration information (S1005). Then, the resource address registering unit 302 newly registers the resource identifier acquired in S1005 and the inputted resource address in the resource list table 311. At this time, the value of the resource address notification event registration 1703 is set to “present,” and the value of the state 1704 is set to “valid” (S1006).

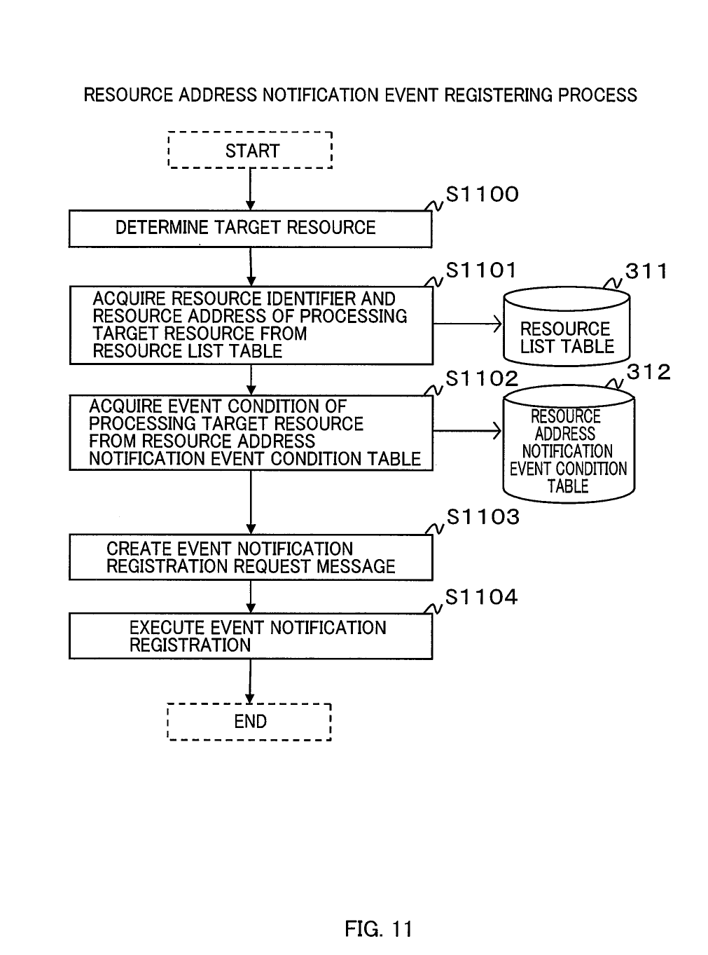

Next, the configuration information managing apparatus 100 performs a resource address notification event registration processing shown in FIG. 11 on the resource address thus found and registered. As shown in the drawing, the resource address notification event registering unit 304 firstly determines the resource to be subjected to the process (hereinafter referred to as a process target resource) (S1100).

Here, methods of determining the process target resource include a method of using all the resources managed by the resource list table 311 as targets, a method of designating the target resource by an operator or the like.

Instead, the configuration information managing apparatus 100 may select the target resource from the resource list table 311 in accordance with a policy that is preset in the configuration information managing apparatus 100. In this case, the policy may be set as “the resource is subjected to the process when the management target resource is an operating system that operates on a virtual machine”, for example.

A judgment as to whether or not the management target resource is the operating system on the virtual machine is made with reference to the resource information table 313 and the inter-resource correlation table 314. When the management target resource is in compliance with the CIM, for example, the virtual machine is expressed as a CIM_ComputerSystem instance and is linked with another CIM_ComputerSystem instance by a CIM_HostedDependency instance (a correlation). Therefore, a judgment as to whether the management target resource is the operating system on the virtual machine can be made depending on whether or not the management target resource is a CIM_OperatingSystem instance linked with the above-described CIM_ComputerSystem instance and a CIM_InstalledOS instance (a correlation).

Next, the resource address notification event registering unit 304 acquires, from the resource list table 311, the resource identifier and the resource address of the process target resource determined in S1100 (S1101). Moreover, the resource address notification event registering unit 304 acquires, from the resource address notification event condition table 312, an event condition 1802 corresponding to the type of the process target resource (a resource type 1801) (S1102).

FIG. 18 shows an example of the resource address notification event condition table 312. The resource type 1801 and the event condition 1802 are associated with each other and are registered in the resource address notification event condition table 312. Information that allows unique identification of the resource type is registered in the resource type 1801. When using the WS-Management or the CIM, a namespace name of the XML Schema used for expressing the resource information is used for a value indicating the resource type. If the resource type is the operating system, for example, a value such as “http://schemas.dmtf.org/wbem/wsCIM/1/CIM-schema/2/CIM_OperatingSystem” is used.

The event condition 1802 indicates the condition for transmitting the resource address notification event. When using the WS-Management or the CIM, for example, a conceivable method of designating the condition for indicating startup of the operating system is to express that a value of an Enabled State property of the CIM_OperatingSystem instance is either “Enabled” or “Starting” by use of the XPath or the CQL (CIM Query Language).

Next, the resource address notification event registering unit 304 creates the event notification registration request message (S1103). In this process, the resource address notification event registering unit 304 creates the event notification destination address that includes the resource identifier acquired in S1101 and the event message reception endpoint of the configuration information managing apparatus 100.

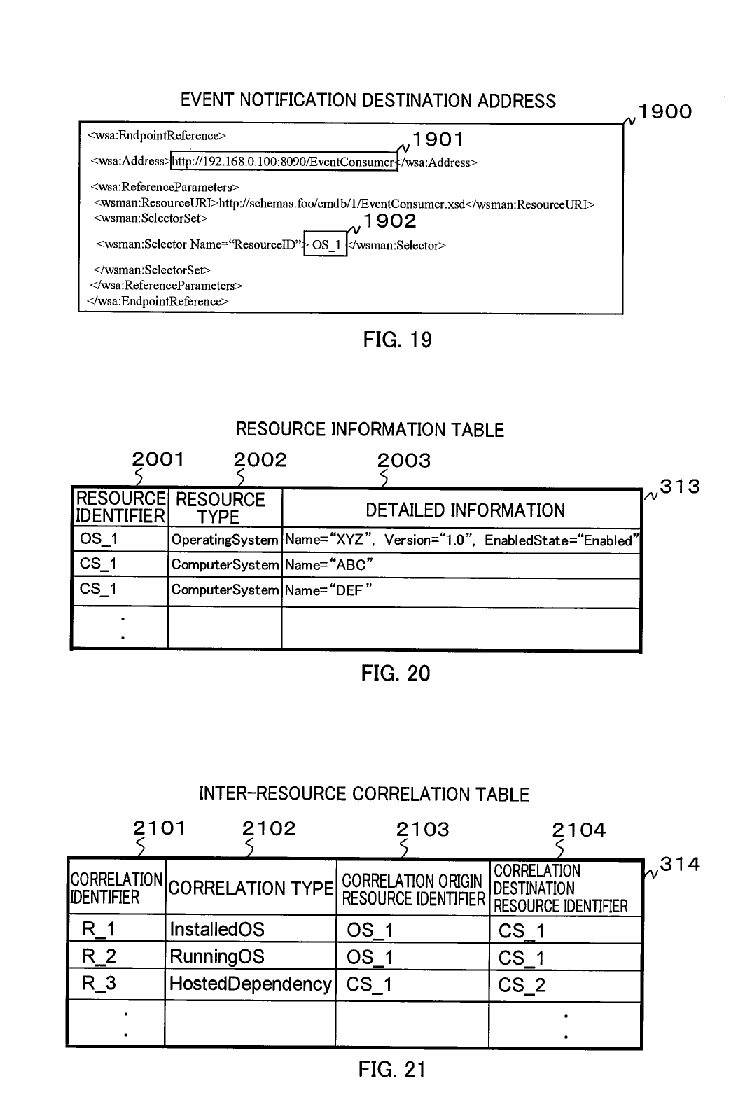

FIG. 19 shows an example of the event notification destination address when using the WS-Management. In the drawing, reference numeral 1901 denotes the event message reception endpoint of the configuration information managing apparatus 100. Reference numeral 1902 denotes the resource identifier acquired in S1101.

Next, the resource address notification event registering unit 304 transmits the event notification registration request message created in S1103 to the resource address acquired in S1101 (S1104). When using the WS-Management, for example, the resource address notification event registering unit 304 transmits a Subscribe request. At this time, a request transmission process to the standard management agent 401 and a reception process from the standard management agent 401 are carried out by the resource access processing unit 306.

Next, collection of the resource information from the management target apparatus 101 and updating of the resource information will be described. In general, there are conceivably two types of a method of collecting the resource information: a pull type and a push type. In the case of the pull type, the configuration information managing apparatus 100 issues a request for collecting the information to the management target resource, whereas in the case of the push type, the management target resource transmits the information to the configuration information managing apparatus 100. As for the timing for collecting the resource information in the case of the pull type, the resource information may be collected periodically or collected upon a request from a user, for example. Meanwhile, as for the timing for collecting the resource information in the case of the push type, the resource information may be collected (transmitted) periodically or collected (transmitted) at the time of a value change, for example.

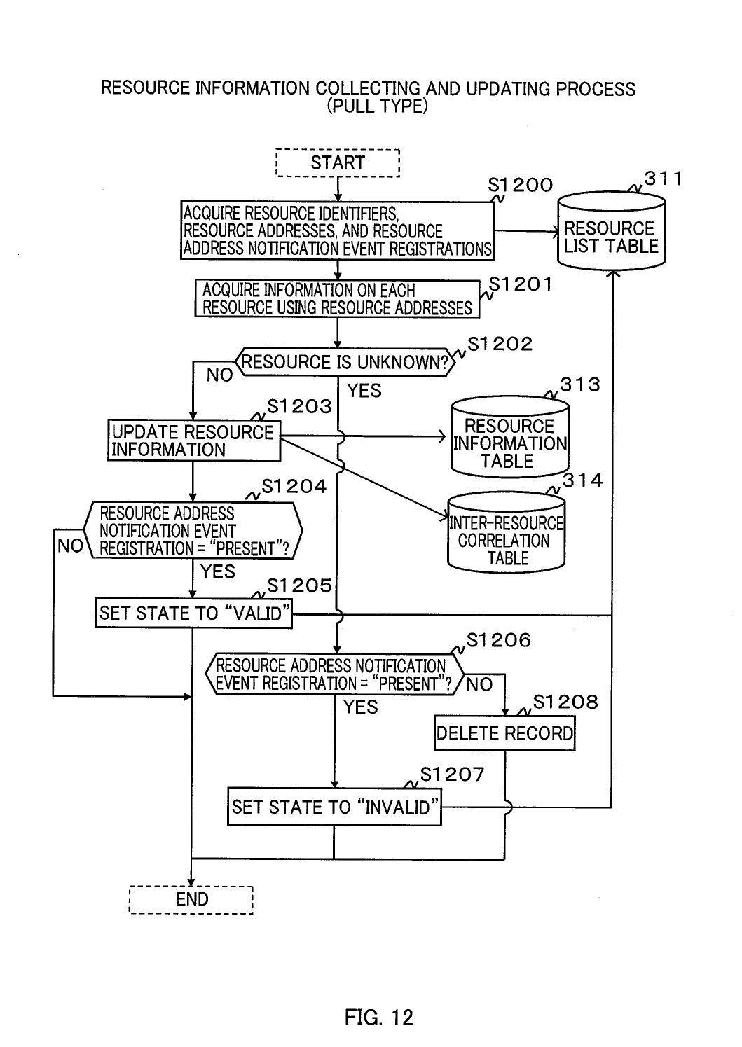

FIG. 12 is a flowchart for explaining a process to be executed by the resource information collecting and updating unit 303 in the case of the pull type. As shown in the drawing, the resource information collecting and updating unit 303 firstly acquires, from the resource list table 311, values of the resource identifier, the resource address, and the resource address notification event registration (S1200).

The resource information collecting and updating unit 303 transmits a resource information acquisition request to each resource address acquired in S1200 and acquires the resource information (S1201). When using the WS-Management, for example, the resource information collecting and updating unit 303 transmits a Get request. A request transmission process to the standard management agent 401 and a reception process from the standard management agent 401 are carried out by the resource access processing unit 306.

Next, the resource information collecting and updating unit 303 checks whether or not a resource corresponding to the resource address used for acquiring the resource information is unknown (S1202). When the resource is unknown, an error message indicating so is transmitted, as a response, from the standard management agent 401.

When the resource is not unknown as a result of S1202 (S1202: NO), the resource information collecting and updating unit 303 searches for a corresponding record from the resource information table 313 or the inter-resource correlation table 314 by using the resource identifier acquired in S1200, and then updates the resource information acquired in S1201 (S1203).

FIG. 20 shows an example of the resource information table 313. A resource identifier 2001, a resource type 2002, and detailed information 2003 are registered in the resource information table 313.

Meanwhile, FIG. 21 shows an example of the inter-resource correlation table 314. A resource identifier 2101, a correlation type 2102, a correlation origin resource identifier 2103, and a correlation destination resource identifier 2104 are registered in the inter-resource correlation table 314.

The correlation type 2102 may conceivably be a correlation expressed by an Association class defined by the CIM, a vendor's original correlation type, and the like. The original correlation type may conceivably be correlations between various objects including a correlation type representing a correlation between management target server application and management target client application, a correlation type representing a correlation between a management target service and management target application constituting the service, a correlation type representing a correlation between a management target application and incident information derived in connection with the application, and a correlation type representing a correlation between a management target resource and change history information concerning the resource, for example.

Next, the resource information collecting and updating unit 303 checks the value of the resource address notification event registration acquired in S1200 (S1204). When the value is “present” as a result of S1204 (S1204: YES), the resource information collecting and updating unit 303 searches for a corresponding record in the resource list table 311 by using the resource identifier acquired in S1200, and then registers the value “valid” in the state 1704 (S1205). On the other hand, when the value is “absent” as a result of S1204 (S1204: NO), the resource information collecting and updating unit 303 terminates the process.

Meanwhile, when the resource is unknown as a result of S1202 (S1202: YES), the resource information collecting and updating unit 303 checks the value of the resource address notification event registration acquired in S1200 (S1206). When the value is “present” as a result of S1206 (S1206: YES), the resource information collecting and updating unit 303 searches for a corresponding record in the resource list table 311 by using the resource identifier acquired in S1200, and registers the value “invalid” in the state 1704 (S1207). On the other hand, when the value is “absent” (S1206: NO), the resource information collecting and updating unit 303 searches for a corresponding record in the resource list table 311 by using the resource identifier acquired in S1200 and then deletes the record (S1208). Specifically, the corresponding record in the resource list table 311 is deleted only when the value of the resource address notification event registration is “absent”. Therefore, the record remains in the resource list table 311 as long as the value of the resource address notification event registration is “present” and becomes a search target in the next search session (S1200).

In this way, the resource address finding and registering process, the resource address notification event registration process, and the resource information collecting and updating process are completed.

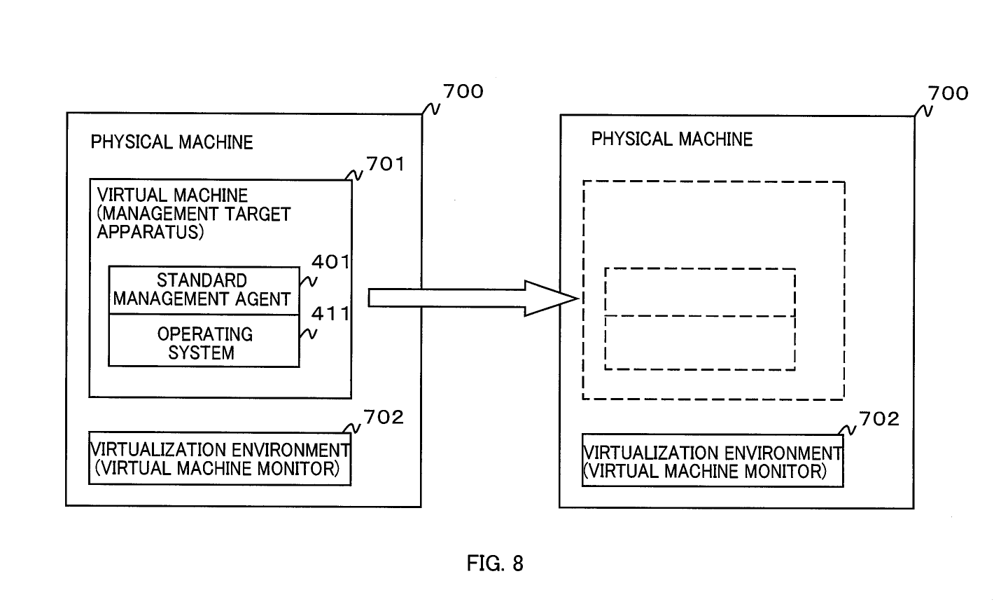

Next, description will be made regarding a process to be executed by the information processing system 1 in the case when migration is carried out for the virtual machine having the configuration shown in FIG. 7 at a certain time point after completing the resource address finding and registering process as well as the resource address notification event registration process, or more specifically in the case when a resource address notification event message is transmitted to the configuration information managing apparatus 100 on the assumption that, as shown in FIG. 8, the management target apparatus 101 being a virtual machine 701 on a virtualization environment 702 configured to be operated on a physical machine 700 moves onto the virtualization environment 702 configured to be operated on the physical machine 700 due to cold migration.

At the time of stop and restart of the virtual machine 701 associated with migration of the virtual machine 701, an operating system is also stopped and restarted. Accordingly, a resource address notification event message is transmitted when the resource address notification event registration executed to the operating system 411 operating on the virtual machine 701 has a condition of the restart of the operating system 411.

Meanwhile, the event reception processing unit 308 receives the event message transmitted to an event message reception endpoint of the configuration information managing apparatus 100. The event message analyzing unit 305 starts a process upon receipt of the event message from the event reception processing unit 308.

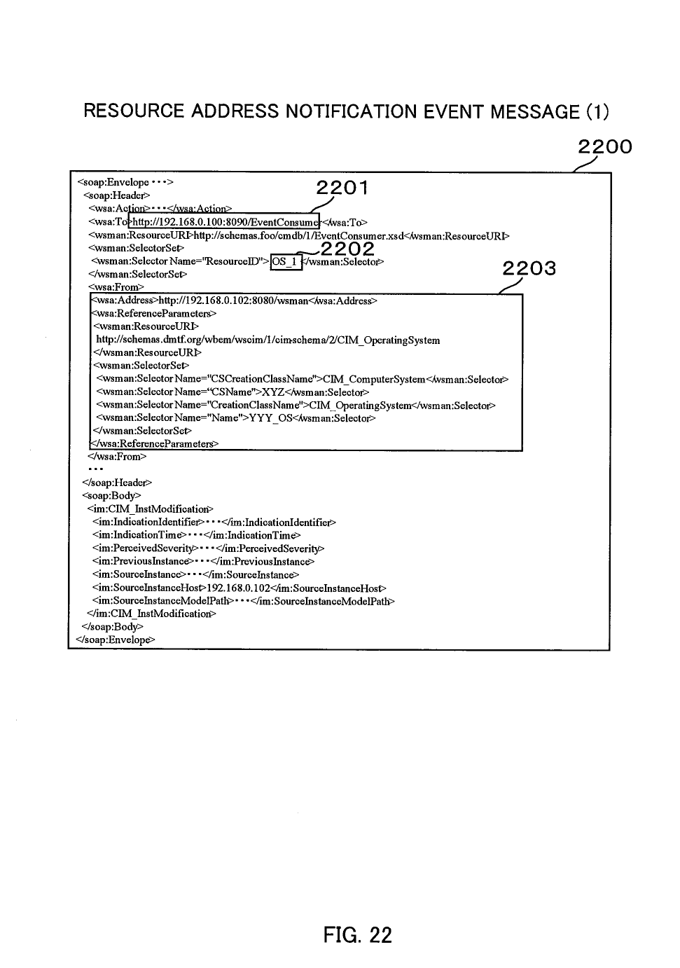

FIG. 22 shows an example of the resource address notification event message. Reference numeral 2201 denotes an event notification destination endpoint, which is the value specified in the event notification destination address in the resource address notification event registration process shown in FIG. 11. Meanwhile, reference numeral 2202 denotes the resource identifier specified in the event notification destination address in the resource address notification event registration process. These pieces of information are retained as the event notification registration information (subscription) by the standard management agent 401 on the management target apparatus 101 before and after migration of the management target apparatus 101.

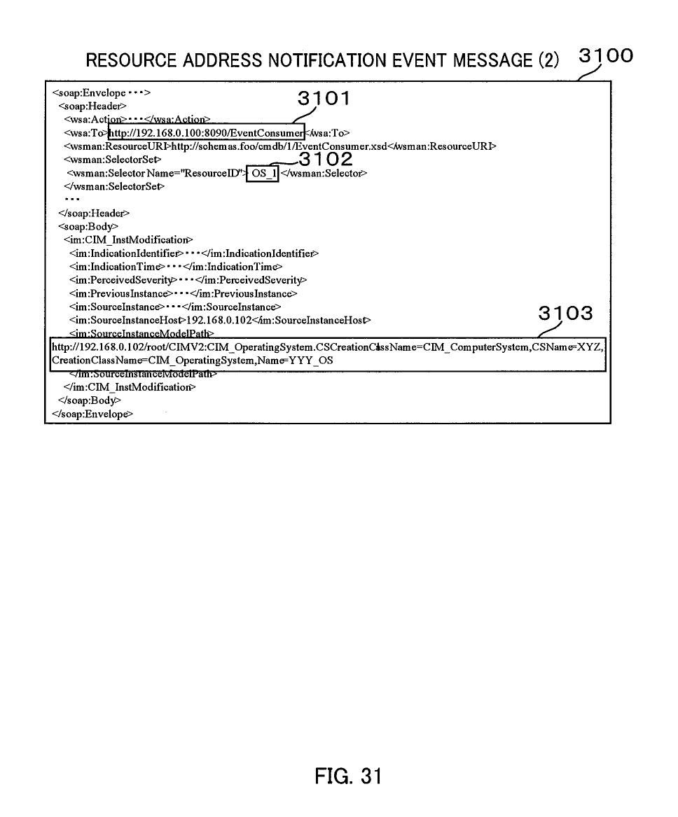

Reference numeral 2203 denotes a resource address of an event sender resource. In the case of the drawing, the event sender resource address exists in a header section of a SOAP message. However, the event sender resource address may exist in a body section of the SOAP message. FIG. 31 shows an example of the resource address notification event message in the case where information on the event sender resource address exists in the body section of the SOAP message. In the drawing, reference numeral 3103 denotes the information on the event sender resource address.

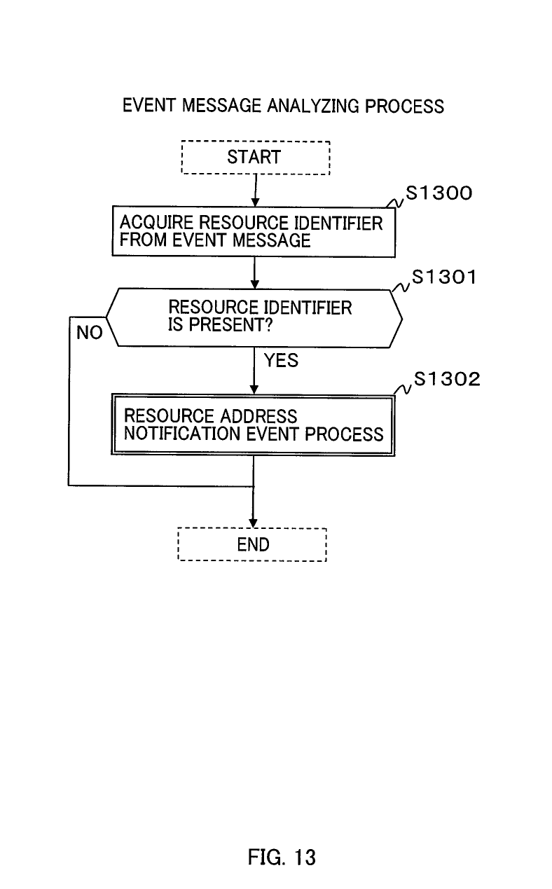

Next, a process to be executed by the event message analyzing unit 305 will be described with reference to a flowchart shown in FIG. 13. The event message analyzing unit starts the process when the configuration information managing apparatus 100 receives the event message that is sent from the management target apparatus 101.

First, the event message analyzing unit 305 acquires the resource identifier from the event message (S1300). The event message analyzing unit 305 checks whether or not the resource identifier exists in the event message (S1301). When the resource identifier exists in the event message (S1301: YES), the process goes to a resource address notification event process denoted by reference numeral S1302. The process is terminated when no resource identifier exists in the event message (S1301: NO).

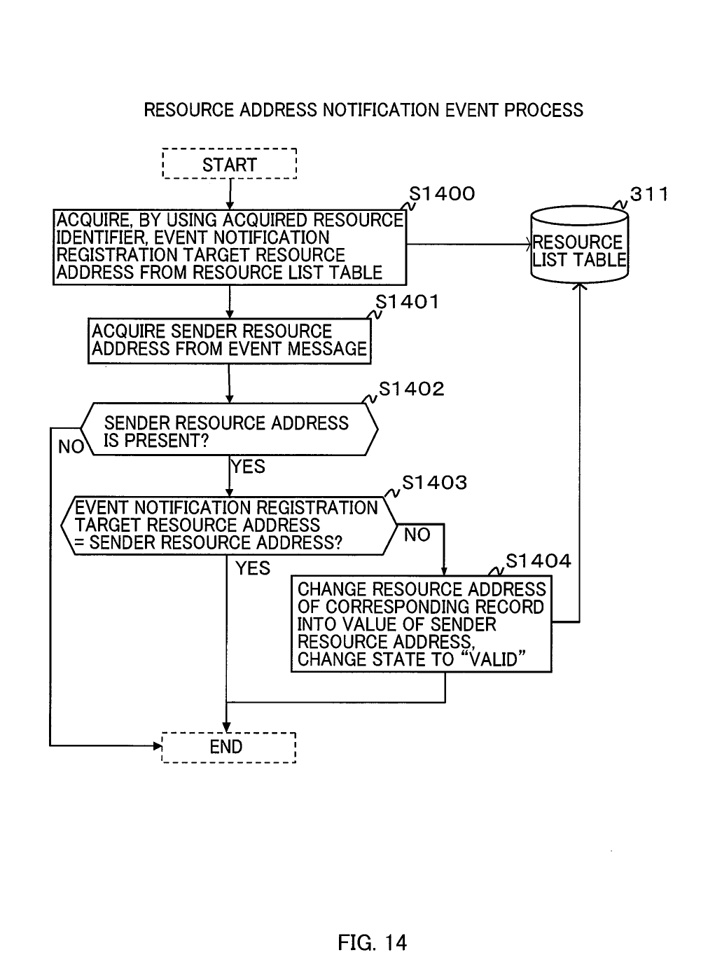

FIG. 14 is a flowchart for explaining the resource address notification event process (S1302) to be executed by the resource address updating unit 307.

The resource address updating unit 307 searches the resource list table 311 for a record matching the resource identifier acquired in S1300 and acquires a resource address of the searched record (such a resource address will be hereinafter referred to as an event notification registration target resource address) (S1400).

Next, the resource address updating unit 307 starts a process to acquire the resource address of the event sender resource from the event message (S1401). The resource address updating unit 307 checks whether or not the resource address of the resource of the sender of the event notification (hereinafter referred to as the event sender resource address) exists in the event message (S1402). When the event sender resource address exists in the event message (S1402: YES), the process goes to S1403. The process is terminated when no event sender resource address exists in the event message (S1402: NO).

The resource address updating unit 307 compares the event notification registration target resource address acquired in S1400 with the event sender resource address (a current resource address) acquired in S1401 (S1403). As a result of comparison, the process is terminated when the value of the event notification registration target resource address is the same as the value of the event sender resource address (S1403: YES), that is, when it is not necessary to change the event notification registration target resource address. On the other hand, the process goes to S1404 when the value of the event notification registration target resource address is different from the value of the event sender resource address (S1403: NO).

In S1404, the resource address updating unit 307 changes the resource address of the corresponding record in the resource list table 311 searched in S1400 into the value of the event sender resource address acquired in S1401, and also register the value “valid” in the state 1704.

A typical case of registering the value “invalid” in the state 1704 among the records in the resource list table 311 may be a case where the standard management agent 401 on the virtual machine is stopped when the virtual machine is stopped by the cold migration and the resource address disclosed by the standard management agent 401 is not usable.

In this way, the resource address updating process for the management target resource to be executed upon receipt of the resource address notification event is completed.

Incidentally, it is also possible to cause the resource address notification event registering unit 304 to execute the event notification registration so as to transmit the event message from the management target apparatus 101 to the configuration information managing apparatus 100 only when the event notification registration target resource address is different from the event sender resource address. In this case, the process goes to S1404 without executing the judgment as described in S1403 when the event sender resource address exists (S1402: YES) as a result of the judgment in S1402.

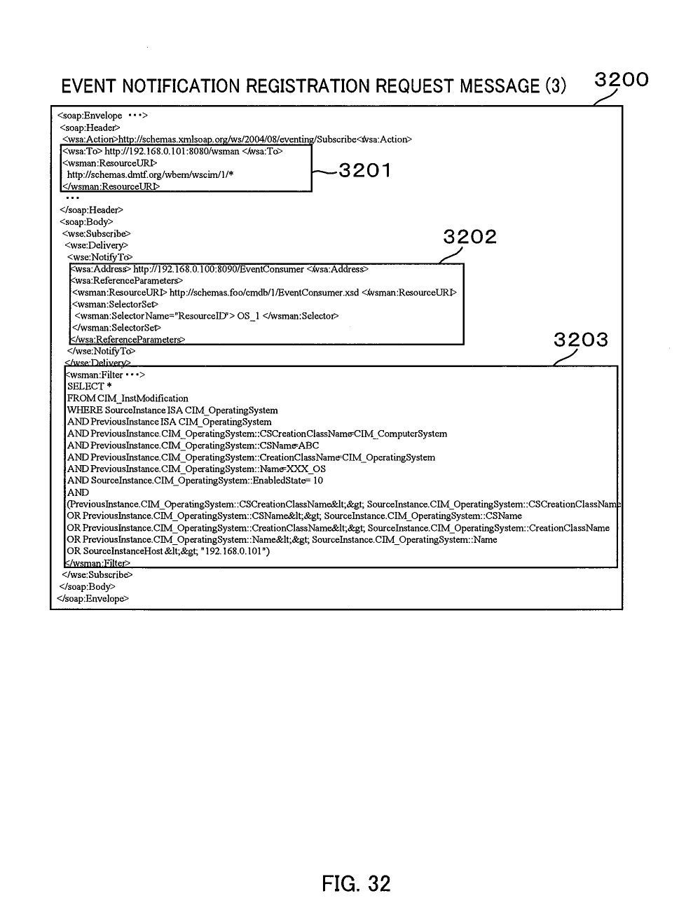

FIG. 32 shows an example of the event notification registration request message. In the drawing, the event firing condition denoted by reference numeral 3203 includes a condition that “the event notification registration target resource address is different from the event sender resource address”.

### Second Embodiment

The first embodiment has described the example of using the pull type resource address finding method. This embodiment will describe a push type resource address finding method.

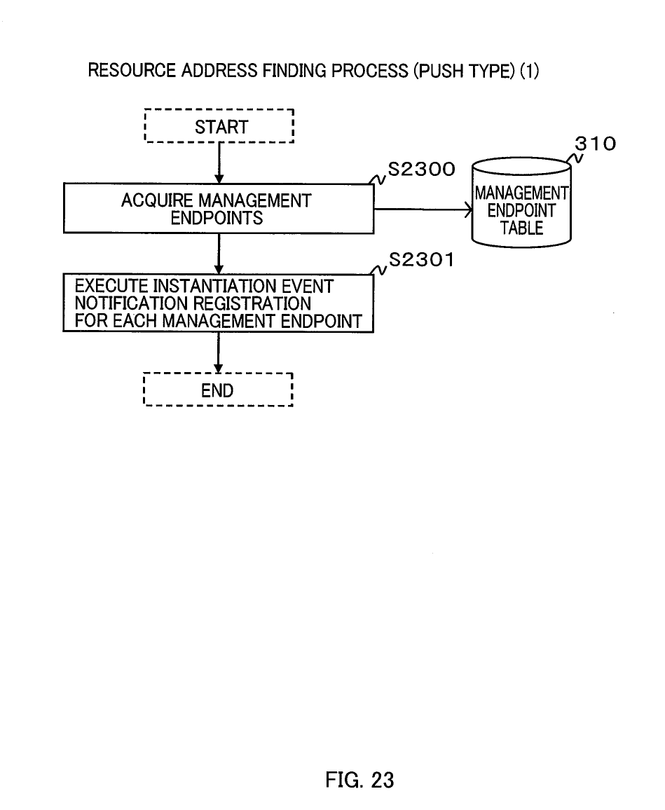

FIG. 23 is a flowchart showing an example of a process to be executed by the resource address finding unit 301. As shown in the drawing, the resource address finding unit 301 firstly acquires management endpoint information from the management endpoint table 310 (S2300).

Next, the resource address finding unit 301 executes an instantiation event notification registration for each management endpoint acquired from the management endpoint table 310 (S2301). When the standard management agent 401 is in compliance with the WS-Management, for example, the resource address finding unit 301 transmits a Subscribe request. Like the first embodiment, a request transmission process to the standard management agent 401 and a reception process of a response from the standard management agent 401 are carried out by the resource access processing unit 306.

In this way, when the management target resource is newly instantiated by the standard management agent 401, an instantiation event message will be transmitted to the configuration information managing apparatus 100.

Next, a process to be executed in the case where the configuration information managing apparatus 100 receives the event message will be described. When the event reception processing unit 308 receives the event message transmitted to the event message reception endpoint of the configuration information managing apparatus 100, the event message analyzing unit 305 receives the event message from the event reception processing unit 308.

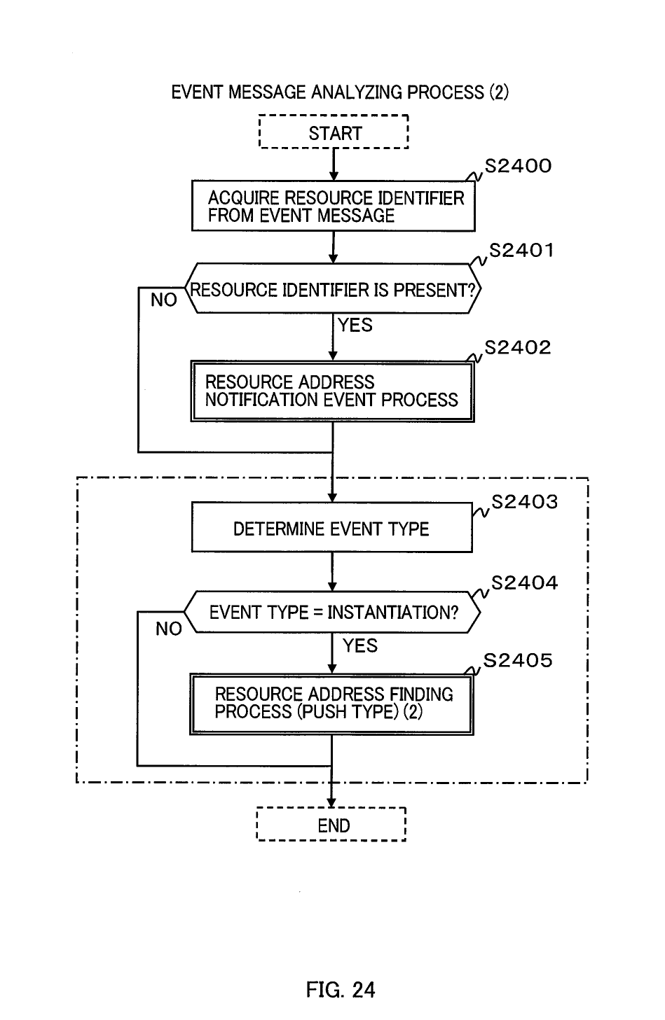

FIG. 24 is a flowchart showing an event message analyzing process of the push type. In this flowchart, processes necessary for the instantiation event reception process are added to the event message analyzing process explained in FIG. 13. The processes from S2400 to S2402 in this drawing are the same as that from S1300 to S1302 in FIG. 13.

In S2403, the event message analyzing unit 305 judges whether or not an event type of the received event message is an instantiation event. The process goes to S2405 when the event type judged in S2403 is an instantiation event (S2404: YES). The process is terminated when the event type is not an instantiation event (S2404: NO).

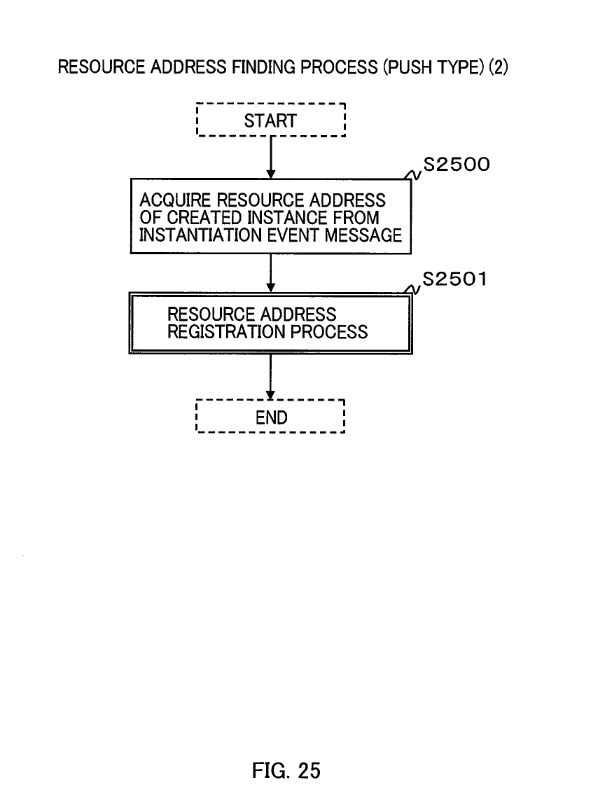

FIG. 25 is a flowchart for explaining a resource address finding process (of the push type) (2) indicated in S2405 in FIG. 24. As shown in the drawing, the resource address finding unit 301 acquires the instantiated resource address from the instantiation event message (S2500). Then, the resource address finding unit 301 calls the resource address registering unit 302 to execute the resource address registration process shown in FIG. 10 (S2501).

### Third Embodiment

The first embodiment has described the example of using the pull-type resource information collecting method. A third embodiment will describe a push-type resource information collecting method.

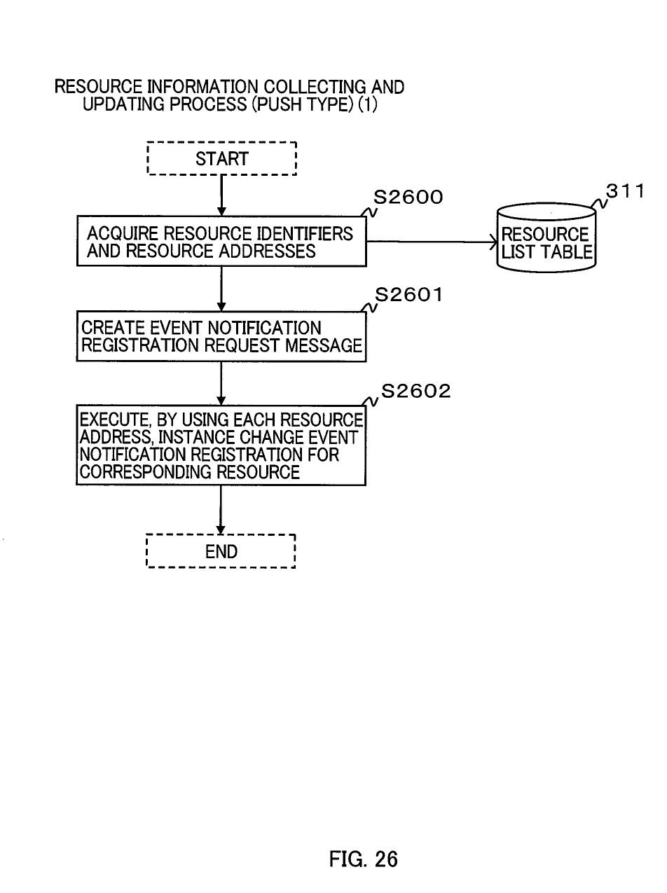

FIG. 26 is a flowchart showing an example of a process to be executed by the resource information collecting and updating unit 303. As shown in the drawing, the resource information collecting and updating unit 303 firstly acquires the resource identifier and the resource address from the resource list table 311 (S2600).

Next, the resource information collecting and updating unit 303 creates the event notification registration request message (S2601). In this process, the resource information collecting and updating unit 303 creates an event notification destination address which includes the resource identifier acquired in S2600 and the event message reception endpoint of the configuration information managing apparatus 100.

The resource information collecting and updating unit 303 executes instance change event notification registration for each resource address acquired in S2600 (S2602). When the standard management agent 401 is in compliance with the WS-Management, the resource information collecting and updating unit 303 transmits a Subscribe request. Like the first embodiment, a request transmission process to the standard management agent 401 and a reception process of a response from the standard management agent 401 are carried out by the resource access processing unit 306.

In this way, when there is a change concerning the management target resource, the standard management agent 401 transmits the instance change event message to the configuration information managing apparatus 100.

Next, a process to be executed when the configuration information managing apparatus 100 receives the event message will be described. When the event reception processing unit 308 receives the event message transmitted to the event message reception endpoint of the configuration information managing apparatus 100, the event message analyzing unit 305 receives the event message from the event reception processing unit 308.

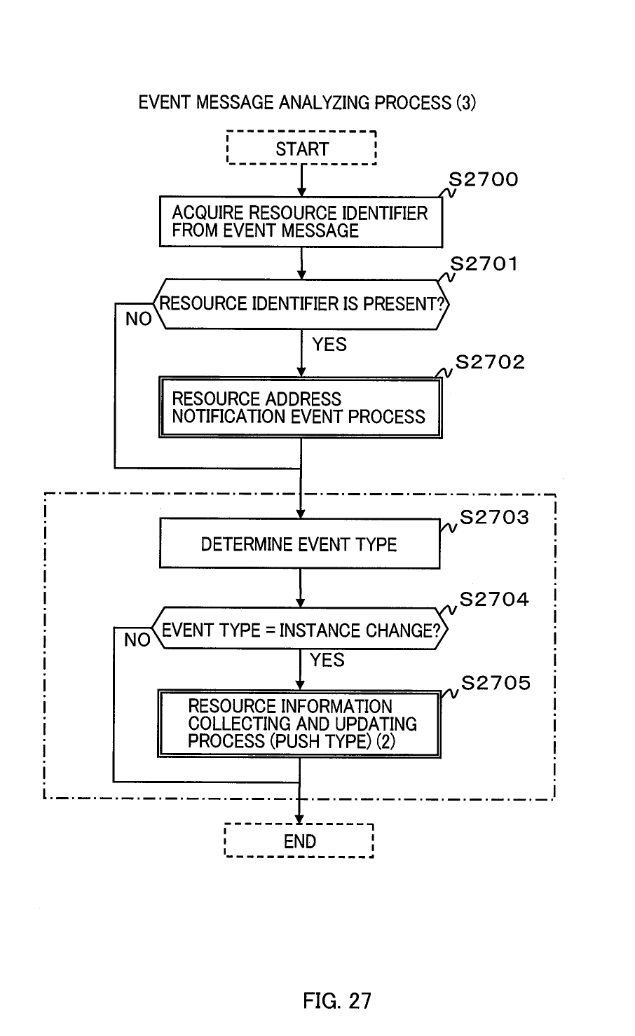

FIG. 27 is a flowchart showing an event message analyzing process of the push type. In this flowchart, processes necessary for the instance change event message reception process are added to the event message analyzing process explained in FIG. 13. The processes from S2700 to S2702 in this drawing are the same as that from S1300 to S1302 in FIG. 13.

After S2702, the event message analyzing unit 305 judges whether or not an event type of the received event message is the instance change event (S2703). The process goes to S2705 when the event type judged in S2703 is the instance change event (S2704: YES). The process is terminated when the event type is not the instance change event (S2704: NO).

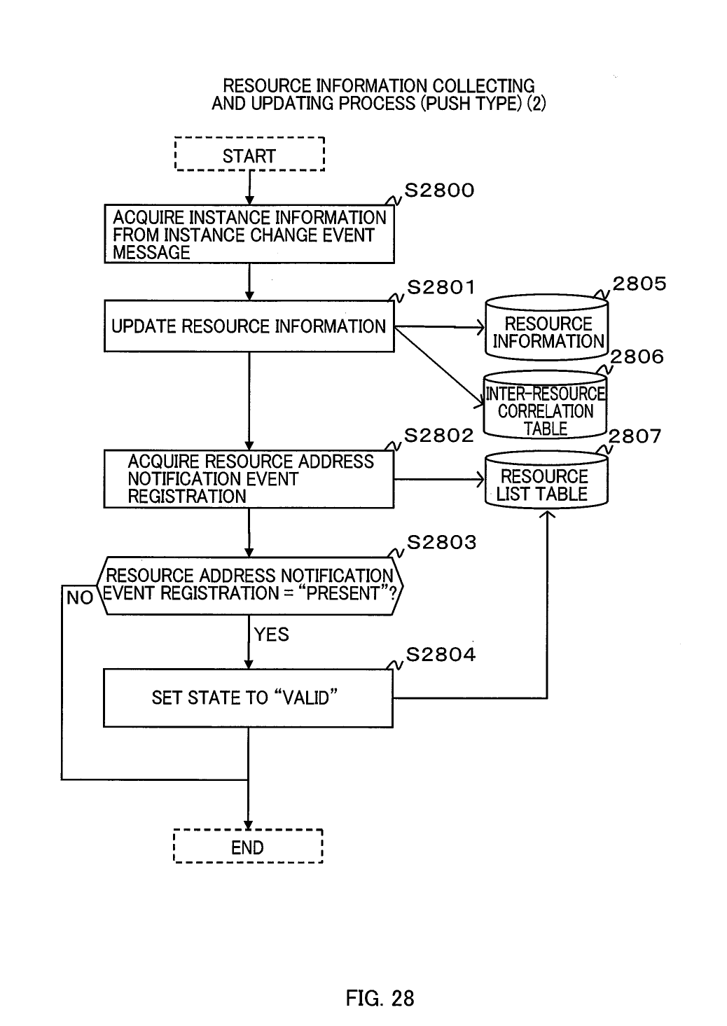

FIG. 28 is a flowchart for explaining a resource address collecting and updating process (of the push type) (2) indicated in S2705 in FIG. 27. First, the resource information collecting and updating unit 303 acquires the instance information from the acquired instance change event message (S2800).

Next, the resource information collecting and updating unit 303 searches for a corresponding record in the resource information table 313 or in the inter-resource correlation table 314 by use of the resource identifier acquired in S2700, and updates the instance information acquired in S2800 (S2801).

The resource information collecting and updating unit 303 acquires the value of the resource address notification event registration from the resource list table 311 by use of the resource identifier acquired in S2700 (S2802).

The resource information collecting and updating unit 303 checks the value of the resource address notification event registration acquired in S2802 (S2803). When the value is “present” (S2803: YES), the resource information collecting and updating unit 303 searches for a corresponding record in the resource list table 311 by use of the resource identifier acquired in S2700, and then registers the value “valid” in the state 1704 (S2804). The process is terminated when the value is “absent” (S2803: NO).

According to the configurations described in the first to third embodiments, the resource can be managed efficiently and appropriately even when the resource address which is the information for identifying or specifying the resource being the management target is changed.

Moreover, the configuration information managing apparatus 100 can identify the operating system 411 operating on the management target apparatus 101 being the virtual machine continuously before and after the migration of the virtual machine. In other words, even when the resource address offered by the operating system 411 operating on the virtual machine is changed by the migration of the virtual machine, it is possible to identify that the resource is the same as the management object resource managed before the migration. Therefore, the configuration information managing apparatus 100 can offer continuous and consistent information to a user of the configuration information managing apparatus 100.

To be more precise, the configuration information managing apparatus 100 can identify the resource on the management target apparatus 101 correctly without falsely recognizing the resource as a different resource when collecting and managing the configuration information of the management target apparatus 101 even when the information on the management target apparatus 101 is changed. For this reason, even in the case of transfer to a different network environment, migration, or a change of a blade server for starting an operating system by use of a shared disk, for example, in the configuration information managing apparatus 100 or the user apparatus 102, it is possible to continuously use, without modification, the existing management information accumulated in connection with the management target resource.

Furthermore, as described previously, in the configuration information managing apparatus 100 of the embodiments, the management target resource is assigned with the resource identifier which uniquely identifies the management target resource. After the environment of the management target resource is changed, the resource identifier and the current resource address associated with the resource identifier are acquired from the management target resource by utilizing the function concerning event notification of the standard management agent 401. Thereby, the resource address associated with the resource identifier and stored in the configuration information managing apparatus 100 is changed into the current resource address.

To be more precise, the configuration information managing apparatus 100 allows the management target resource to store the information for receiving the event notification and the resource identifier by use of the function of the standard management agent 401 acquires the resource identifier and the resource address currently attached to the management target resource upon receipt of the event notification from the standard management agent 401, and change the resource address stored and associated with the resource identifier into the current resource address.

As described above, storage of the resource identifier into the management target apparatus 101 or acquisition of the resource identifier and the currently attached resource address from the management target resource is performed by use of the function of the standard management agent 401. For this reason, it is not necessary to prepare a special agent for the management target apparatus 101 in order to achieve the information processing system 1 of the present embodiments, and it is possible to manage the configuration information of the management target resource efficiently without complicating the information processing system 1 or increasing operational burdens.

Incidentally, when the standard management agent 401 permits state information (a property) concerning the management target resource to be set (or written) from outside, it is also conceivable to allow the configuration information managing apparatus 100 to retain the resource identifier by use of the state information.

However, the standard management agent 401 often prohibits information writing from outside in light of security reasons, and therefore cannot apply such a method in many cases. Moreover, in the information processing system 1 configured to allow multiple configuration information managing apparatuses 100 to access the same management target resource, it is not possible to allow each of the configuration information managing apparatuses 100 to retain the resource identifier by using the same property.

By contrast, according to the configurations of the embodiments, it is possible to allow each of the configuration information managing apparatuses 100 to retain different types of event notification registration information (subscription). Therefore, each configuration information managing apparatus 100 can manage the resource identifier individually while ensuring the security.

It is to be noted that the description in the embodiments is intended to facilitate understandings of the gist of the present invention but is not intended to limit the scope of the invention. In this context, it is needless to say that the present invention can be modified and improved without departing from the scope thereof and that the present invention and that all the equivalents thereto are encompassed by the invention.

What is claimed is:

1. A resource management method for causing a first information processing apparatus that is communicably connected to a second information processing apparatus to execute the steps of:
storing an identifier of a resource, which is a management target, of the second information processing apparatus, and a resource address being information for specifying the resource, in association with each other;
causing the second information processing apparatus to store destination information and the identifier of the resource in association with each other, the destination information used for the first information processing apparatus to receive an event notification from the resource;
acquiring the identifier of the resource and a resource address currently given to the resource upon reception of the event notification from the resource; and
changing the stored resource address which is associated with the acquired identifier of the resource into the acquired current resource address.

2. The resource management method according to claim 1, further comprising the step of:
the first information processing apparatus storing information indicating any of validity and invalidity of the resource address, in association with the stored resource address.

3. The resource management method according to claim 1, further comprising the step of:
the first information processing apparatus causing the second information processing apparatus to store, in association with the destination information, a condition that the resource address stored by the first information processing apparatus is different from the current resource address, as a condition for determining whether to transmit the event notification to the first information processing apparatus.

4. The resource management method according to claim 1,
wherein the resource address is described based on the Web Services Addressing specifications.

5. A resource management method for an information processing apparatus in an information processing system provided with a plurality of information processing apparatuses communicably connected to one another, the method comprising the steps of:
a first information processing apparatus storing an identifier of a resource, which is a management target, of a second information processing apparatus, and a resource address for specifying the resource, in association with each other;
the second information processing apparatus storing destination information and the identifier of the resource in association with each other, the destination information used for the first information processing apparatus to receive an event notification from resource;
the second information processing apparatus transmitting the identifier of the resource and a resource address currently given to the resource when transmitting the event notification concerning the resource to the first information processing apparatus;
the first information processing apparatus receiving the event notification, the identifier of the resource, and the current resource address when receiving the event notification from the resource; and
the first information processing apparatus changing the stored resource address which is associated with the acquired identifier of the resource into the acquired current resource address.

6. The resource management method according to claim 5,
wherein a function of a standard management agent operating on the second information processing apparatus is used for executing the step of storing by the second information processing apparatus the destination information and the identifier of the resource in association with each other, the destination information used for the first information processing apparatus to receive the event notification from the resource.

7. The resource management method according to claim 5,
wherein a function of a standard management agent operating on the second information processing apparatus is used for executing the step of transmitting by the second information processing apparatus the identifier of the resource and the resource address currently given to the resource when transmitting the event notification concerning the resource to the first information processing apparatus.

8. An information processing system provided with a plurality of information processing apparatuses communicably connected to one another, the information processing system comprising:
a unit, included in a first information processing apparatus, storing an identifier of a resource, which is a management target, of a second information processing apparatus, and a resource address being information for specifying the resource, in association with each other;
a unit, included in the second information processing apparatus, storing destination information and the identifier of the resource, in association with each other, the destination information used for the first information processing to receive an event notification from the resource;
a unit, included in the second information processing apparatus, transmitting the identifier of the resource and a resource address currently given to the resource when transmitting the event notification concerning the resource to the first information processing apparatus;
a unit, included in the first information processing apparatus, receiving the event notification, the identifier of the resource, and the current resource address when receiving the event notification from the resource, and
a unit, included in the first information processing apparatus, changing the stored resource address which is associated with the acquired identifier of the resource into the acquired current resource address.

9. An information processing apparatus comprising:
each of the units included in the first information processing apparatus in the information processing system according to claim 8.

10. An information processing apparatus comprising:
each of the units included in the second information processing apparatus in the information processing system according to claim 8.

11. A program for causing a first information processing apparatus that is communicably connected to a second information processing apparatus to perform the steps of:
storing an identifier of a resource, which is a management target, of the second information processing apparatus, and a resource address being information for specifying the resource, in association with each other;
causing the second information processing apparatus to store destination information and the identifier of the resource, in association with each other, the destination information used for the first information processing apparatus to receive an event notification from the resource;
acquiring the identifier of the resource and a resource address currently given to the resource upon reception of the event notification from the resource; and
changing the stored resource address which is associated with the acquired identifier of the resource into the acquired current resource address.
